(19) United States
(12) Patent Application Publication
(10) Pub. No.: US 2025/0085548 A1
(43) Pub. Date: Mar. 13, 2025

(54) LIGHT FIELD DISPLAY MODULE

(71) Applicant: Industrial Technology Research Institute, Hsinchu (TW)

(72) Inventors: Szu-Wei Wu, Taoyuan City (TW); Yi-Hsiang Huang, Changhua County (TW); Chia-Ping Lin, Taipei City (TW); Yu-Hsiang Liu, Chiayi City (TW); Hung Tsou, Hsinchu County (TW)

(73) Assignee: Industrial Technology Research Institute, Hsinchu (TW)

(21) Appl. No.: 18/792,539

(22) Filed: Aug. 1, 2024

Related U.S. Application Data
(60) Provisional application No. 63/537,197, filed on Sep. 7, 2023.

(30) Foreign Application Priority Data
May 6, 2024 (TW) 113116691

(51) Int. Cl. G02B 27/01

(52) U.S. Cl. CPC G02B 27/0172

(57) ABSTRACT

A light field display module including a light field display layer, an adjustment layer, and an image forming layer is provided. The light field display layer is configured to form a light field image beam. The adjustment layer is disposed on a path of the light field image beam, and configured to adjust the light field image beam. The image forming layer is disposed on the path of the light field image beam from the adjustment layer, and configured to change a position of a light field image by changing a direction of the light field image beam. The image forming layer has multiple optical micro-structures.

### CROSS-REFERENCE TO RELATED APPLICATION

This application claims the priority benefits of U.S. provisional application Ser. No. 63/537,197, filed on Sep. 7, 2023, and Taiwan application serial no. 113116691, filed on May 6, 2024. The entirety of each of the above-mentioned patent applications is hereby incorporated by reference herein.

### TECHNICAL FIELD

The disclosure relates to a light field display module.

### BACKGROUND

With the advancement of display technology, it has been possible to form a display image in the air for users to watch, that is, to form a floating image. For example, head-up display (HUD) is an application of display technology that forms floating images.

Before the development of head-up displays, users had to shift their gaze from paying attention to the car ahead to the dashboard when driving a car to check speed, other driving data, or warning signals. When the car is driving at high speed, moving your eyes away from the front will increase the risk, and moving your eyes back and forth between the front of the car and the dashboard will cause visual fatigue.

For example, the head-up display can display a flat virtual image in front of the car. Although this prevents the driver's eyes from shifting to the dashboard, since the flat virtual image is located at a fixed and single focal length, it is still easy to cause visual focus fatigue. The display content is relatively monotonous and difficult to have more diverse applications, and the image does not change at different viewing angles.

### SUMMARY

An embodiment of the disclosure provides a light field display module, which includes a light field display layer, an adjustment layer, and an image forming layer. The light field display layer is configured to form the light field image beam. The adjustment layer is disposed on a path of the light field image beam and is configured to adjust the light field image beam. The image forming layer is disposed on a path of the light field image beam from the adjustment layer, and is configured to change a direction of the light field image beam to change a position of the light field image. The image forming layer has multiple optical micro-structures.

An embodiment of the disclosure provides the light field display module, which includes the light field display layer, the adjustment layer, and the image forming layer. The light field display layer is configured to form the light field image beam. The adjustment layer is disposed on the path of the light field image beam and is configured to adjust the light field image beam. The image forming layer is disposed on the path of the light field image beam from the adjustment layer, and is configured to change the direction of the light field image beam to change the position of the light field image. The image forming layer has a partially transparent and partially reflective film.

### BRIEF DESCRIPTION OF THE DRAWINGS

FIG. 1 is a schematic diagram of a light field display module according to an embodiment of the disclosure.

FIG. 2 is a schematic diagram of an image forming layer in FIG. 1 changing a position of a light field image.

FIG. 3 is a schematic diagram of a light field display module according to another embodiment of the disclosure.

FIG. 4 is a schematic diagram of a possible angle between the image forming layer and the light field display layer of FIG. 3 in yet another embodiment.

FIG. 5 is a schematic diagram of a light field display module according to yet another embodiment of the disclosure.

FIG. 6 is a schematic diagram of a light field display module according to another embodiment of the disclosure.

FIG. 7 is a schematic diagram of a light field display module according to another embodiment of the disclosure.

FIG. 8 is a schematic diagram of a light field display module according to yet another embodiment of the disclosure.

FIG. 9 is a schematic diagram of a light field display module according to another embodiment of the disclosure.

### DETAILED DESCRIPTION OF DISCLOSED EMBODIMENTS

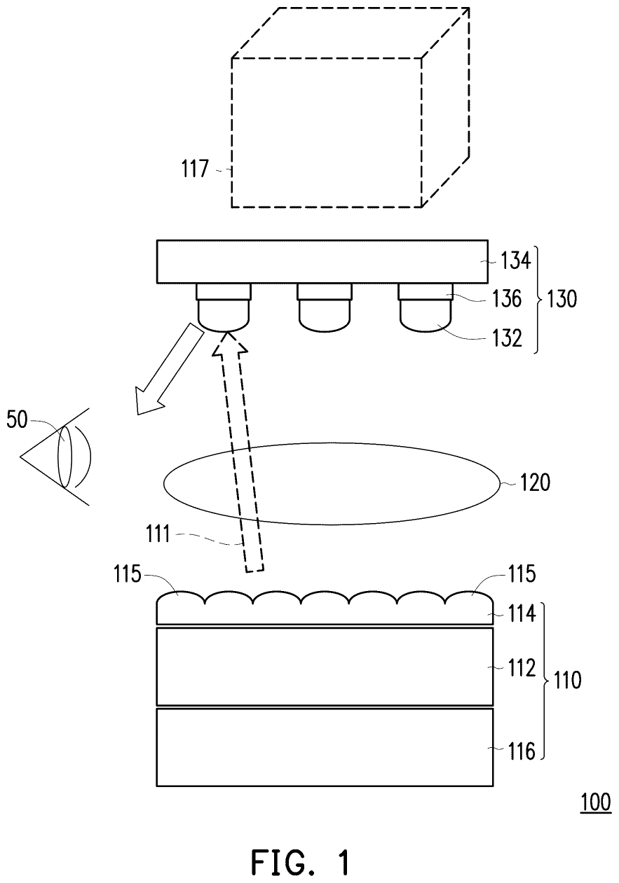

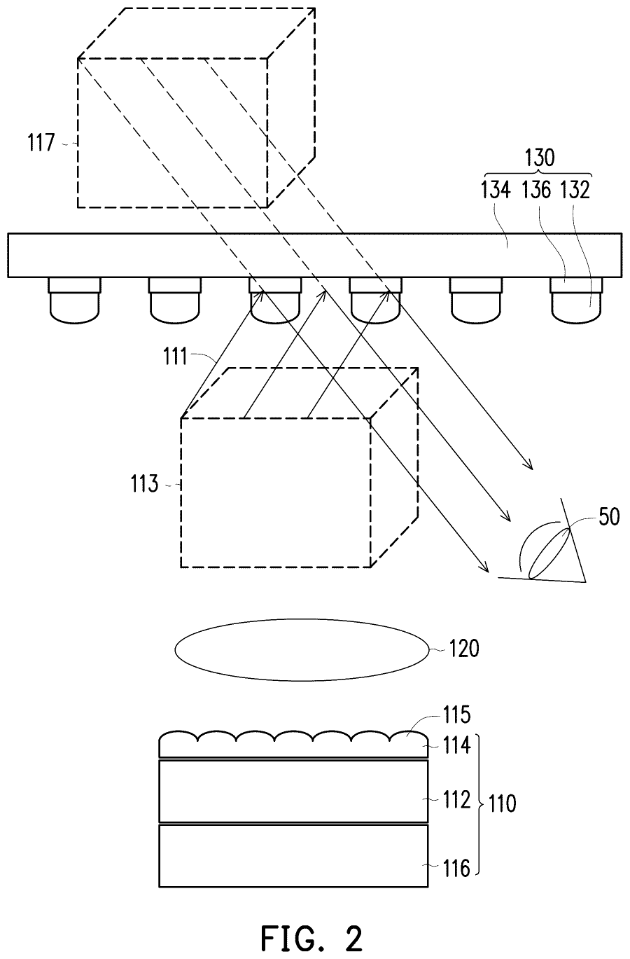

FIG. 1 is a schematic diagram of a light field display module according to an embodiment of the disclosure. FIG. 2 is a schematic diagram of an image forming layer in FIG. 1 changing a position of a light field image. Referring to FIG. 1 and FIG. 2, a light field display module 100 of this embodiment may include a light field display layer 110, an adjustment layer 120, and an image forming layer 130. The light field display layer 110 is used to form a light field image beam 111. In this embodiment, the light field display layer 110 may include a display panel 112 and a light field light guide plate 114. The light field light guide plate 114 is disposed on the display panel 112 to guide a pixel image of the display panel 112 into a light field image 113 (as shown in FIG. 2). In this embodiment, the display panel 112 is, for example, a liquid crystal display panel or an electrowetting display panel, etc. The light field display layer 110 may further include a backlight source 116, which is, for example, a plane light source, to provide an illumination required by the display panel 112. The display panel 112 converts the illumination into an image beam, and the light field light guide plate 114 converts the image beam into the light field image beam 111. In this embodiment, the light field light guide plate 114 includes, for example, a lens array plate, which may have microlenses 115 arranged in an array to guide the pixel images located at different positions on the display panel 112 into the light field image 113. The light field image 113 may be a static image, a dynamic image, a stereoscopic image, or a combination thereof. In other embodiments, the display panel 112 may be replaced with a photomask sheet with high-resolution graphics, with areas of the graphics being opaque and the rest being transparent to allow backlight to pass through, or vice versa (i.e., areas having the graphics being transparent and the rest being opaque). Alternatively, in other embodiments, the backlight source 116 may be replaced with a projector as a device that provides a high-resolution image source, and the display panel 112 may be replaced with a projection screen. The image of the projector may be formed on the projection screen. Alternatively, in other embodiments, the display panel 112 may be a self-luminous display panel, such as an organic light-emitting diode display panel, a micro-LED display panel, etc., and in this case, the backlight source 116 may not be required. Alternatively, in other embodiments, the display panel 112 may be replaced by a pattern sheet. The pattern sheet is disposed on the backlight source 116. The light field light guide plate 114 is disposed on the pattern sheet to guide the image on the pattern sheet illuminated by the backlight source 116 into a light field image.

The adjustment layer 120 is disposed on a path of the light field image beam 111 and is used to adjust the light field image beam 111. The adjustment layer 120 may be used to control a display range, an imaging angle, a distance, a zoom, a directionality, an imaging depth of field, a size, etc. In this embodiment, the adjustment layer 120 is, for example, a lens, which may modify image distortion and avoid loss of optical information. For example, using lenses with different curvatures, such as convex lenses with light-gathering effects, may shrink the image (opposite with concave lenses), or lenses with free-form surfaces may distort the refraction angle of light to achieve the effect of trimming the image and avoiding information loss.

The image forming layer 130 is disposed on the path of the light field image beam 111 from the adjustment layer 120 and is used to change the direction of the light field image beam 111 to change the position of the light field image 113 (for example, changing the position of the light field image 113 in FIG. 2 to the position of a light field image 117). The image forming layer 130 may have multiple optical micro-structures 132.

In this embodiment, the image forming layer 130 may include a light-transmitting substrate 134 and multiple reflective portions 136 separated from each other. The reflective portions 136 separated from each other are located on the light-transmitting substrate 134. The optical micro-structures 132 are respectively disposed on the light-transmitting substrate 134 corresponding to the reflective portions 136.

In this embodiment, each of the reflective portions 136 is a reflective layer. The light field image beam 111 from the adjustment layer 120 is transmitted to an eye 50 of an user by passing through the optical micro-structures 132, being reflected by the reflective layers (i.e., the reflective portion 136), and then passing through the optical micro-structures 132 to generate a virtual image (i.e., the light field image 117, as shown in FIG. 2) on the side of the light-transmitting substrate 134 relative to the optical micro-structures 132. In this embodiment, the optical micro-structures 132 are located between the adjustment layer 120 and the light-transmitting substrate 134. In an embodiment, the optical micro-structures 132 include, for example, multiple micro lenses arranged in an array.

In the light field display module 100 of this embodiment, the image forming layer 130 has the reflective portions 136 that are separated from each other. The entirety of the reflective portions 136 that are separated from each other may be regarded as a semi-transmissive film. The reflective portions 136 that are separated from each other may partially reflect the light field image beam 111 to the eye 50 of the user so that the eye 50 may see the light field image 117 located on another side of the image forming layer 130. In addition, the light emitted by an external object located on another side of the image forming layer 130 relative to the eye 50 may penetrate through gaps between the reflective portions 136 that are separated from each other and be transmitted to the eye 50 of the user, so the user may not only see the light field image 117, but also see the environmental scene to achieve the effect of augmented reality. For example, in a driving situation, the light field display module 100 may provide relevant information that is integrated with the real scene, and the user may simultaneously see the real scenes without affecting driving safety. In an embodiment, by adjusting a reflectivity of the light field display layer 110 or the reflective portion 136 of the image forming layer 130 through the matching of a structural angle/material of the light field image beam 111 and the adjustment layer 120, the contrast of the light field image 117 and the environmental scene may be controlled as, for example, greater than 1.04, thereby optimizing a light field display quality.

In the light field display module 100 of this embodiment, the light field display layer 110 is used to form the light field image 113, and the image forming layer 130 is used to change the direction of the light field image beam 111, thereby changing the position of the light field image 113. The light field display module 100 of this embodiment may provide images with stereoscopic depth information, and the images provided may be viewed from different viewing angles with changes. At the same time, the structure of the light field display module 100 may be flexibly changed according to needs, thereby being highly adaptable to different application fields. In addition, the light field image 113 may deliver richer and more complete image information content, enabling diverse display applications. The display with stereoscopic depth information in this embodiment may provide a proper display effect than a flat image head-up display, improve the issue of a narrow display area, and achieve pillar to pillar visibility. Furthermore, the light field display module 100 of this embodiment may be used as a light field display head-up display system with the stereoscopic depth information, which may be matched with a suitable system architecture according to different environments and purpose requirements to enhance reception of user information and increase interactivity, thereby meeting the needs of various fields and expanding an application market.

The light field display module 100 of this embodiment may be applied in more diverse environments, such as vehicle-mounted display, engineering construction auxiliary display, medical auxiliary display, education, etc. Taking the vehicle-mounted display as an example, the light field display module 100 of this embodiment allows users (such as drivers, passengers, etc.) to easily understand the driving situation and may adapt to different angles and heights of pillar to pillar due to multiple focusing planes. In addition, the light field display module 100 of this embodiment has depth-of-field projection capability, which can reduce focusing fatigue of the user.

In addition, the light field display module 100 may be used with different architectures in various usage scenarios to achieve more diverse display application effects. Other architectures are introduced one by one below.

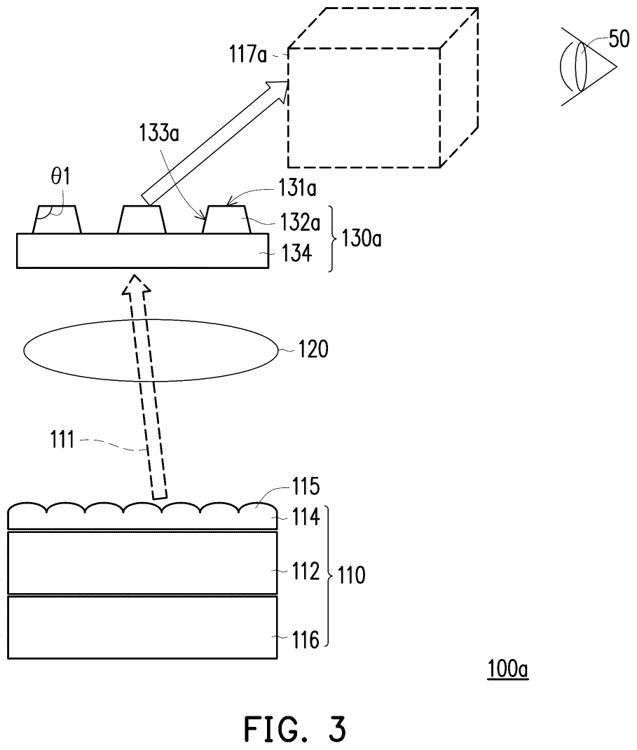

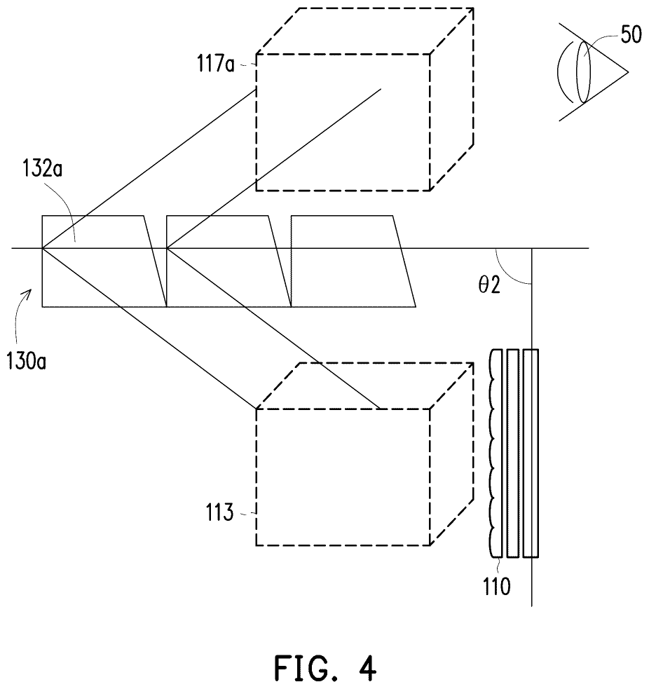

FIG. 3 is a schematic diagram of a light field display module according to another embodiment of the disclosure. FIG. 4 is a schematic diagram of a possible angle between the image forming layer and the light field display layer of FIG. 3 in yet another embodiment. Referring to FIG. 3 first, a light field display module 100a of this embodiment is similar to the light field display module 100 of FIG. 1, and the main differences between the two are as follows. In an image forming layer 130a of the light field display module 100a in this embodiment, multiple optical micro-structures 132a are multiple micro prisms configured on the light-transmitting substrate 134. In this embodiment, the light-transmitting substrate 134 is located between the micro prisms (i.e., the optical micro-structures 132a) and the adjustment layer 120. In this embodiment, each of the micro prisms has an upper surface 131a facing away from the light-transmitting substrate 134 and a side surface 133a connecting the upper surface 131a and the light-transmitting substrate 134. The light field image beam 111 from the adjustment layer 120 may form a light field image 117a at a side of the light-transmitting substrate 134 provided with the micro prisms (i.e., the optical micro-structures 132a) by penetrating the light-transmitting substrate 134, being reflected by the side surfaces 133a of the micro prisms (for example, total reflection), and penetrating the upper surfaces 131a of the micro prisms. In an embodiment, an internal angle θ1 formed by the upper surface 131a and the side surface 133a is an obtuse angle. In another embodiment, as shown in FIG. 4, an angle θ2 of the image forming layer 130a and the light field display layer 110 falls within a range of 30 degrees to 90 degrees. Such a design allows the eye 50 of the user to view the light field image 117a on a side of the light-transmitting substrate 134 provided with the micro prisms (i.e., the optical micro-structures 132a).

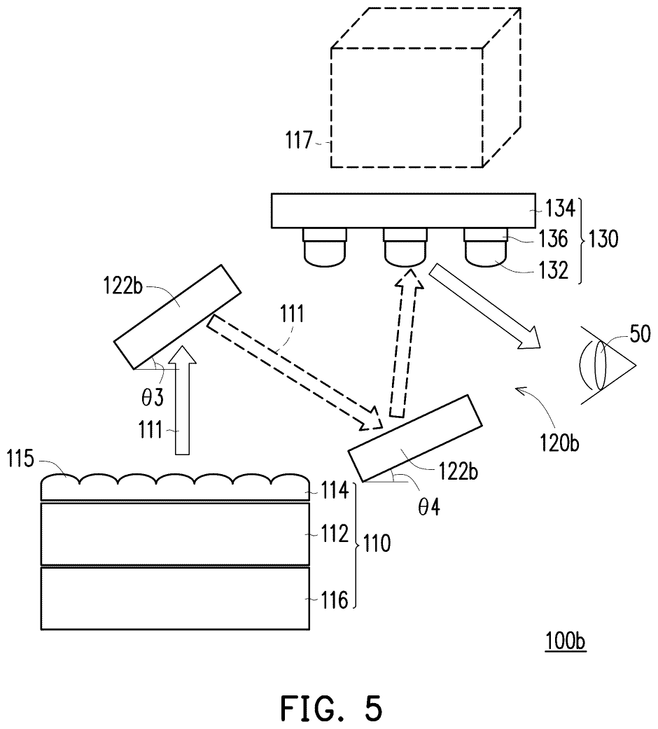

FIG. 5 is a schematic diagram of a light field display module according to yet another embodiment of the disclosure. Referring to FIG. 5, a light field display module 100b of this embodiment is similar to the light field display module 100 of FIG. 1, and the main differences between the two are as follows. In the light field display module 100b of this embodiment, an adjustment layer 120b includes at least one reflector 122b (in FIG. 5, multiple reflectors 122b are taken as an example). The light field image beam 111 is sequentially reflected by the reflectors 122b and transmitted to the image forming layer 130. The size of the reflectors 122b may increase with the order in which the light field image beam 111 is transmitted. For example, the size of the reflector 122b at the right side in FIG. 5 may be larger than the size of the reflector 122b at the left side. In this embodiment, an angle θ3 or θ4 between the reflector 122b and the image forming layer 130 may be less than or equal to 90 degrees. In FIG. 5, the reflector 122b is a plane mirror as an example. However, in other embodiments, the reflector 122b may include a convex mirror, a concave mirror, a plane mirror, or a combination thereof.

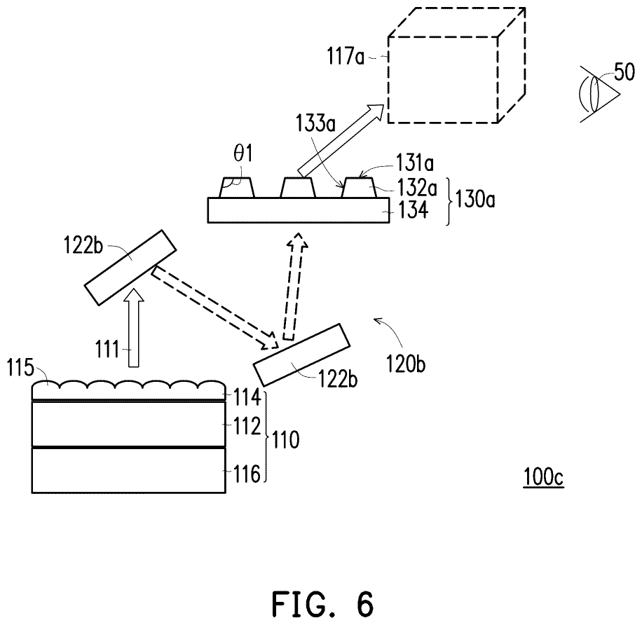

FIG. 6 is a schematic diagram of a light field display module according to another embodiment of the disclosure. Referring to FIG. 6, a light field display module 100c of this embodiment is similar to the light field display module 100a of FIG. 3, and the main differences between the two are as follows. In the light field display module 100c of this embodiment, the adjustment layer 120b may adopt the adjustment layer as shown in FIG. 5.

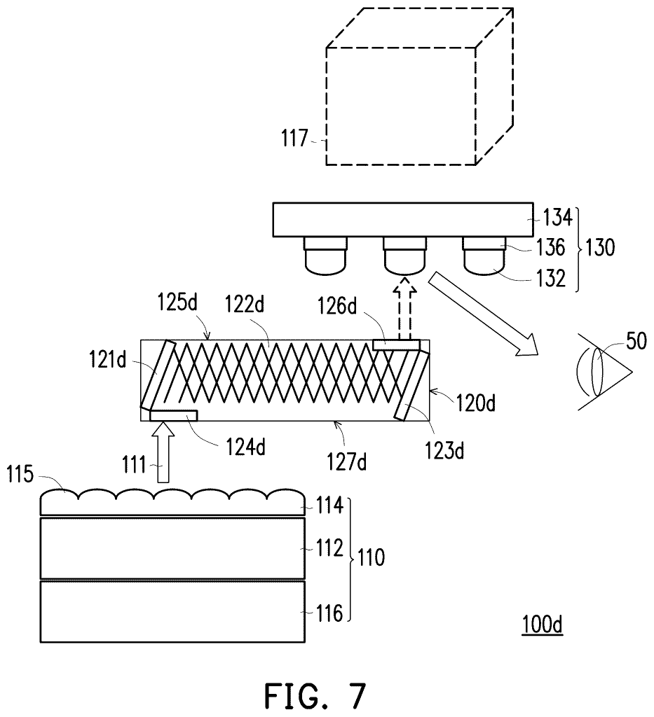

FIG. 7 is a schematic diagram of a light field display module according to

another embodiment of the disclosure. Referring to FIG. 7, a light field display module 100d of this embodiment is similar to the light field display module 100 of FIG. 1, and the main differences between the two are as follows. In the light field display module 100d of this embodiment, an adjustment layer 120d may be an optical waveguide. In this embodiment, the adjustment layer 120d (i.e., the optical waveguide) has a waveguide body 122d, a light entrance portion 124d, a first light guide portion 121d, a second light guide portion 123d, and a light emitting portion 126d. The first light guide portion 121d and the second light guide portion 123d are, for example, reflective layers, and the light entrance portion 124d and the light emitting portion 126d are, for example, optical structures, optical films, or other appropriate structures. The optical structure is, for example, a lens, and the optical film is, for example, an anti-reflective film. The light field image beam 111 from the light field light guide plate 114 enters the waveguide body 122d through the light entrance portion 124d, is reflected by the first light guide portion 121d, and then is continuously totally reflected by an upper surface 125d and a lower surface 127d of the waveguide body 122d opposite to each other, thereby being limited in the waveguide body 122d and transmitted in the waveguide body 122d. When the light field image beam 111 is transmitted to the second light guide portion 123d in the waveguide body 122d, the light field image beam 111 is reflected by the second light guide portion 123d so that the traveling direction is changed, and leaves the waveguide body 122d from the light emitting portion 126d, thereby being transmitted to the image forming layer 130.

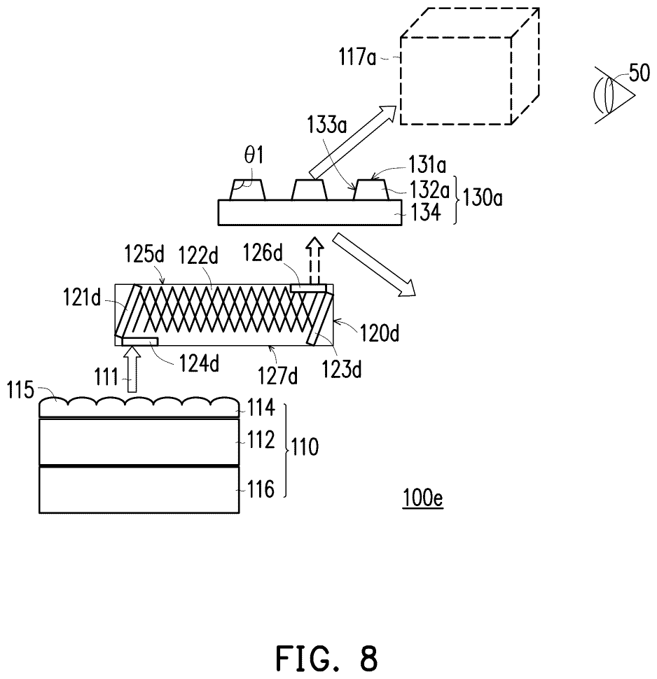

FIG. 8 is a schematic diagram of a light field display module according to yet another embodiment of the disclosure. Referring to FIG. 8, a light field display module 100e of this embodiment is similar to the light field display module 100a of FIG. 3, and the main differences between the two are as follows. In the light field display module 100e of this embodiment, the adjustment layer 120d may adopt the optical waveguide as shown in FIG. 7.

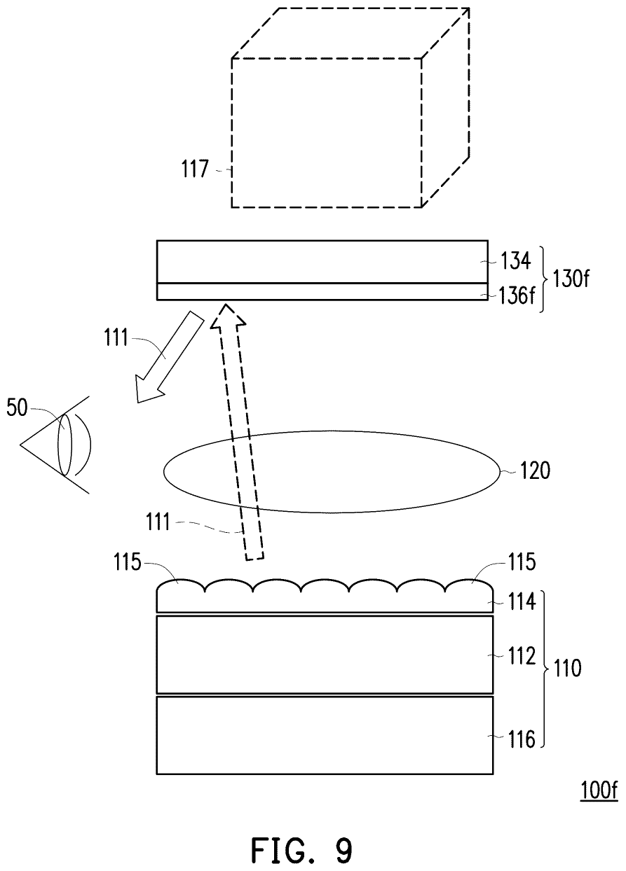

FIG. 9 is a schematic diagram of a light field display module according to another embodiment of the disclosure. Referring to FIG. 9, a light field display module 100f of this embodiment is similar to the light field display module 100 of FIG. 1, and the main differences between the two are as follows. In the light field display module 100f of this embodiment, an image forming layer 130f has a semi-transmissive film 136f. For example, the semi-transmissive film 136f may be a transflective film, which is disposed on the light-transmitting substrate 134 of the image forming layer 130f. The semi-transmissive film 136f may partially reflect the light field image beam 111 to the eye 50 of the user, so that the eye 50 may see the light field image 117 located on another side of the image forming layer 130f. In addition, the scene located on another side of the image forming layer 130f relative to the eye 50 may be observed by the user through the semi-transmissive film 136f. The user may not only see the light field image 117, but also see the outside scene to achieve the effect of augmented reality.

In the light field display module according to the embodiment of the disclosure, the light field display layer is used to form the light field image. The image forming layer is used to change the direction of the light field image beam, thereby changing the position of the light field image. The light field display module according to the embodiment of the disclosure may provide the image with the stereoscopic depth information and changing when viewed from different viewing angles. The structure may be flexibly changed according to needs, providing a highly adaptability to different application fields. In the light field display module according to the embodiment of the disclosure, the light field display layer may generate light field information; the adjustment layer may modify image distortion and/or avoid loss of optical information; the image forming layer may control the position of the light field image, and generate the light field image through the combination of the light field display layer, the adjustment layer, and the image forming layer, forming a stereoscopic light field display structure.

What is claimed is:

1. A light field display module, comprising:
a light field display layer, configured to form a light field image beam;
an adjustment layer, disposed on a path of the light field image beam and configured to adjust the light field image beam; and
an image forming layer, disposed on a path of the light field image beam from the adjustment layer, and configured to change a direction of the light field image beam to change a position of the light field image, wherein the image forming layer has a plurality of optical micro-structures.

2. The light field display module according to claim 1, wherein the image forming layer comprises:
a light-transmitting substrate; and
a plurality of reflective portions separated from each other, located on the light-transmitting substrate, wherein the plurality of optical micro-structures are respectively configured on the light-transmitting substrate corresponding to the plurality of reflective portions.

3. The light field display module according to claim 2, wherein each of the reflective portions is a reflective layer, and the light field image beam from the adjustment layer is transmitted to an eye of a user by passing through the plurality of optical micro-structures, being reflected by the reflective layers, and then passing through the plurality of optical micro-structures to generate a virtual image on a side of the light-transmitting substrate relative to the plurality of optical micro-structures.

4. The light field display module according to claim 2, wherein the plurality of optical micro-structures are located between the adjustment layer and the light-transmitting substrate.

5. The light field display module according to claim 1, wherein the light field display layer comprises:
a display panel; and
a light field light guide plate, disposed on the display panel to guide a pixel image of the display panel into a light field image.

6. The light field display module according to claim 5, wherein the light field light guide plate is a lens array plate.

7. The light field display module according to claim 1, wherein the adjustment layer comprises a lens or at least one reflector.

8. The light field display module according to claim 7, wherein an angle between the at least one reflector and the image forming layer is less than or equal to 90 degrees.

9. The light field display module according to claim 7, wherein the at least one reflecting mirror comprises a convex mirror, a concave mirror, a plane mirror, or a combination thereof.

10. The light field display module according to claim 1, wherein the adjustment layer comprises a plurality of reflectors, and the light field image beam is reflected by the plurality of reflectors and transmitted to the image forming layer, wherein a size of the plurality of reflectors increases with an order in which the light field image beam is transmitted.

11. The light field display module according to claim 1, wherein the image forming layer comprises:
a light-transmitting substrate, wherein the plurality of optical micro-structures are a plurality of micro prisms configured on the light-transmitting substrate.

12. The light field display module according to claim 11, wherein the light-transmitting substrate is located between the plurality of micro prisms and the adjustment layer.

13. The light field display module according to claim 12, wherein each of the micro prisms has an upper surface facing away from the light-transmitting substrate and a side surface connecting the upper surface and the light-transmitting substrate, the light field image beam from the adjustment layer forms a light field image on a side of the light-transmitting substrate provided with the micro-prisms by penetrating the light-transmitting substrate, being reflected by a side surface of the plurality of micro prisms, and penetrating a upper surface of the plurality of micro prisms.

14. The light field display module according to claim 13, wherein an internal angle between the upper surface and the side surface is an obtuse angle.

15. The light field display module according to claim 11, wherein an angle between the image forming layer and the light field display layer is in a range of 30 degrees to 90 degrees.

16. The light field display module according to claim 1, wherein the adjustment layer is an optical waveguide.

17. The light field display module according to claim 1, wherein the light field display layer comprises:
a backlight source;
a pattern sheet, configured on the backlight source; and
a light field light guide plate, disposed on the pattern sheet to guide an image on the pattern sheet into a light field image.

18. The light field display module according to claim 17, wherein the light field light guide plate is a lens array plate.

19. A light field display module, comprising:
a light field display layer, configured to form a light field image beam;
an adjustment layer, disposed on a path of the light field image beam and configured to adjust the light field image beam; and
an image forming layer, disposed on a path of the light field image beam from the adjustment layer, and configured to change a direction of the light field image beam to change a position of the light field image, wherein the image forming layer has a semi-transmissive film.
